(19) United States
(12) Patent Application Publication
(10) Pub. No.: US 2017/0120963 A1
(43) Pub. Date: May 4, 2017

(54) Glide Mechanism for an Automotive Storage Container

(71) Applicants: Robert Roach, Holt, MI (US); Craig Wieland, Mason, MI (US)

(72) Inventors: Robert Roach, Holt, MI (US); Craig Wieland, Mason, MI (US)

(21) Appl. No.: 14/928,023

(22) Filed: Oct. 30, 2015

(51) Int. Cl. B62D 33/08; B60R 9/06

(52) U.S. Cl. CPC B62D 33/08; B60R 9/065

(57) ABSTRACT

Example movement apparatus to position a storage container with respect to a vehicle surface are disclosed. An example movement apparatus to guide a storage container in a vehicle cargo area includes a base portion secured to the vehicle cargo area, the base portion extending along at least a portion of a length of the vehicle cargo area, the base portion configured to facilitate movement of the storage container along the base portion. The example movement apparatus also includes an attachment mechanism to receive and hold the storage container with respect to the base portion, the attachment mechanism to hold the storage container and allow the storage container to move with respect to the base portion via the attachment mechanism.

### FIELD

The present embodiments generally relate to automotive storage containers, and, more specifically, to glide mechanisms for automotive storage containers.

### BACKGROUND

Automobiles or vehicles are often used to carry personal and/or commercial cargo. A pickup truck (which may be referred to as a truck) is a motor vehicle or automobile with an open-top rear cargo area which is generally (but does not have to be) separated from a cabin to allow for chassis flex when carrying or pulling heavy loads. The open-top rear cargo area is generally referred to as the bed of the truck. The bed of the truck is generally configured to store, carry, or haul various items. However, because the bed of the truck has an open top (e.g., is not covered), the various items are generally exposed to the weather and/or the possibility of theft. Furthermore, because the bed of the truck is generally sized to store, carry, or haul larger items (e.g., gravel and wood), smaller items (e.g., groceries or tools) may slide around the bed of the truck. For some items, such as gravel, wood, landscaping items, etc., being exposed to the possibility of weather, theft, and sliding around is generally not a problem. However, for other items, such as carpentry tools, groceries, clothes, etc., being exposed to the possibility of weather, theft, and sliding around is generally not acceptable. In some situations, the person using the truck may choose to place these items in the cabin of the truck to prevent exposure. Existing containers are inflexible and inadequate to accommodate access in a way that is convenient from the rear of the truck bed. Containers for trailers and other vehicles with flat storage areas suffer from similar deficiencies.

### BRIEF DESCRIPTION OF THE DRAWINGS

Example embodiments are described herein with reference to the following drawings.

FIG. 1 illustrates an example of a storage container in a back of a vehicle such as a truck.

FIG. 2 illustrates an example in which a storage container is positioned at an end of a cargo area such as a truck bed.

FIG. 3 illustrates an example of a storage container with an independently movable top panel and front panel.

FIG. 4 illustrates an example front panel for a storage container.

FIG. 5 depicts an example storage container including a moveable front panel.

FIG. 6 shows an example storage container including moveable front and top panels.

FIGS. 7A-7E illustrate example configurations for movement of a front panel into a cavity under the base of the storage container.

FIG. 8 illustrates a front view of an example storage container shown open and laying on a truck tailgate.

FIG. 9 illustrates a front view of the example storage container of FIG. 8 with the front panel slid into a cavity in the storage container.

FIGS. 10A-10B illustrate example views of a glide mechanism moving a container from a position in a bed/cargo area of a truck to a position over a tailgate.

FIGS. 11A-11B depict an example glide or movement apparatus including a top portion resting on and moveable with respect to a bottom portion.

FIGS. 12A-12B illustrate views of an example glide mechanism.

FIG. 13 shows an example glide mechanism including holes or slots allowing the glide mechanism to be universally installed in variety of vehicles.

FIG. 14 shows a base portion of an example glide mechanism with an added fabric tab on an end of the mounting plate under the base portion of the glide mechanism.

FIG. 15A-15B show example glide mechanisms in which a rubber mounting bushing is mounted under a bottom portion of the glide mechanism.

FIGS. 16A-16D show an alternate fastener between an example glide mechanism and its vehicle surface.

FIG. 17 shows an alternate method to hold the glide mechanism in a vehicle cargo area using a heavy mat.

FIG. 18 depicts an example glide mechanism base including a groove for alignment and movement of a storage container.

FIGS. 19A-19B illustrate an example bolt in a top plate of a glide apparatus to be aligned with a groove in the base of the glide apparatus.

FIG. 20 illustrates an example end plate to help prevent a glide mechanism from moving away from an end of a cargo area in which the glide mechanism is mounted.

FIGS. 21A-21B show an example screw that can be threaded into a base plate from a top plate of an example glide mechanism to prevent the top plate from moving when threaded.

FIG. 22 illustrates an alternative example “fast track” glide mechanism.

FIG. 23 shows a closer view of an example indexing clip.

FIG. 24 depicts a profile view of an example base plate and foot of an example glide mechanism.

FIG. 25 is another illustration of a glide base including a foot, an indexing clip, and a screw.

FIG. 26 shows another alternative embodiment of a glide mechanism in which a ball and tube implementation joins the base portion and upper portion of the example glide mechanism.

The following detailed description may be better understood when read in conjunction with the drawings which show certain example embodiments. The drawings are for the purpose of illustrating concepts, but it is understood that the inventions are not limited to the arrangements and instrumentality shown in the drawings.

### DETAILED DESCRIPTION OF CERTAIN EMBODIMENTS

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe certain example implementations and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### BRIEF DESCRIPTION

Certain examples relate to glide mechanisms for an automotive storage container for an automobile, such as a truck, car, van, sport utility vehicle (SUV), all-terrain vehicle (ATV) (e.g., quad, quad bike, three wheeler, four wheeler, etc.), recreational vehicle (RV), boat, airplane, etc. Flat cargo trailers (e.g., for transport of snowmobiles, motorcycles, ATVs, etc.) can also utilize a storage container mounted and/or otherwise positioned on a glide mechanism.

Certain examples provide a movement or “glide” device mounted to, connected to, and/or integrated with a storage container in a back or bed of an automobile. The storage container can include a collapsible storage container, a non-collapsible storage container, a plurality of storage containers, etc. In certain examples, the storage container includes a movable top and/or front panel. Some examples of a collapsible storage container including a movable top and/or front panel can be found in U.S. Pat. No. 8,701,950, commonly owned and invented by the inventors/applicants of the present patent, and which is incorporated by reference herein in its entirety for all purposes.

Using the slide or glide movement device or apparatus, the attached storage container can be positioned (e.g., pushed, pulled, slid, etc., along the glide mechanism) at various points including but not limited to an end or tailgate of the automobile bed. For example, the storage container can be pulled along the glide mechanism until it rests at the end of a truck's tailgate. As a result, a user can reach right into the storage container rather than having to climb in or awkwardly stretch to access the storage container from a distance (e.g., with the length of the tailgate in the way).

In some examples, the glide mechanism includes a plurality of detents, stops, or stays which allow the storage container to stop at various points along the glide mechanism. The glide mechanism can lock in place to keep the attached container from sliding back and forth when in a desired position, for example. The glide mechanism can also include a guard or stop at one or more ends of the glide apparatus to prevent the storage container from moving off of the glide, for example.

In some examples, the guard(s) can be removable to allow the storage container to be detached or otherwise removed from the glide apparatus. In some examples, the storage container can be snapped, clasped, clipped, bolted, or otherwise removably affixed to the glide mechanism. In other examples, the storage container can be integrated with and/or otherwise permanently affixed to the glide mechanism. In some examples, the glide mechanism can include openings and/or wider portions to allow the container to be lifted free of the glide apparatus.

In an example, a truck includes a truck bed or storage area with a moveable tailgate at one end of the bed. The moveable tailgate opens and closes to allow access into the truck bed. Guide rails can be mounted in the truck bed, and a storage container can be mounted on the guide rails. Rather than having to reach over the tailgate and reach into the bed to access the storage container, the guide rails allow the storage container to be positioned to the edge of the tailgate to provide easier access to the storage container. Additionally, instead of having an open front panel protruding from the container causing a user to reach over the front panel to access the interior of the container, enabling the front panel to slide into a cavity at the bottom of the storage container allows a user to move right up against the container at the edge of the tailgate to access the interior of the container without intervening obstacles. Thus, rather than having to back up because front panel is sticking out, the front panel slides under a base of the container so the user can stand flush with the container and pull the container forward along the guide rails.

Reference herein to “embodiment” means that a feature, structure, or characteristic described in connection with the embodiment can be included in at least one embodiment. The appearance of this phrase in various places in the specification is not necessarily all referring to the same or single embodiment or even different and mutually exclusive embodiments. Separate or alternative embodiments are not mutually exclusive embodiments. Instead, the embodiments described herein, explicitly and implicitly understood by one skilled in the art, may be combined with other embodiments. The embodiments and combinations thereof are all within the scope of this patent document.

It is also worth noting that unless stated otherwise the various embodiments disclosed herein are not limited in their application to the details of design and arrangement of the components set forth in the previous and following description or as illustrated in the drawings. Instead, the foregoing description, following description, and the drawings focus on presenting concepts of various embodiments. The embodiments described herein may stand alone or be combined with each other.

One or more of the embodiments may be implemented as a method, system, article of manufacture, apparatus, or device. It should be noted that the methods, systems, articles of manufacture, apparatus, and devices provided herein are merely illustrative and should not be considered as limiting. Accordingly, while the following describes example methods, systems, articles of manufacture, and apparatus, the examples provided are not the only way to implement such methods, systems, articles of manufacture, and apparatus.

### DETAILED DESCRIPTION

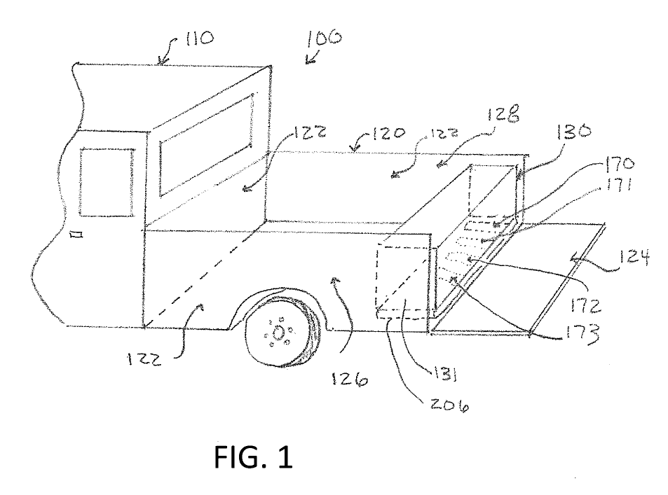

FIG. 1 illustrates a truck 100. The truck 100 is described and disclosed herein for purposes of example illustration only. Other vehicles, such as trailers, flatbed trucks, SUVs, ATVs, RVs, etc., can be substituted for the truck 100 in the example of FIG. 1. The truck 100 includes a cabin 110 and a bed or cargo area 120. The bed 120 is generally (but does not have to be) separated from (e.g., independent of) the cabin 110 to allow for chassis flex when carrying or pulling heavy loads. The cabin 110 is coupled with the bed 120. As used herein, the term “coupled with” may include a direct connection or indirect connection via one or more intermediary components. For example, the cabin 110 may be welded directly to the bed 120 or connected via a motor-vehicle chassis. The truck 100 may include additional, different, or fewer components.

The truck 100 shown in FIG. 1 is a pickup truck. An example pickup truck includes side walls along the edge of the bed 120. However, in some examples, a storage container can be installed in or used with a vehicle that is pulling a trailer or even a semi-truck. For example, a storage container may be installed on a trailer that does not include as many (e.g., relative to a pickup) or any side walls along the edges of the floor of the trailer. In another example, a storage container may be installed in a semi-truck (e.g., near the rear doors, in a vertical plane on the back wall of the cabin, etc.). In another example, a storage container may be installed in a vertical plane along a back wall and/or side wall of a recreational vehicle (RV), sport utility vehicle (SUV), etc.

The cabin 110 is an enclosed space where at least the driver is seated when driving the truck 100. The cabin 110 may be referred to as a “cab.” The cabin 110 may be any now known or later developed cabin of a truck. For example, the cabin 110 may be a standard cabin, extended (or super) cabin, or crew cabin. A standard cabin has a single row of seats and a single set of doors, one on each side. Most pickups have a front bench seat that can be used by two or more people; however, various manufacturers have begun to offer individual seats with a console in the middle of the seats. An extended cabin includes additional space behind the main seating area. This additional space may be accessed by reclining the front bench forward or rear access door on one or both sides of the cabin 110. A rear access door may be a door hinged on the trailing edge, which is the edge closer to the rear of the truck 100. One or more seats may be placed in the area behind the front bench. For example, in an embodiment, the cabin 110 may include a side-facing seat that can fold into the walls behind the front bench. However, in other examples, a full bench may be placed in the back. A crew cabin may be a cabin with four-doors. A crew cabin includes seating for up to five or six people on two full benches and full-size front-hinged doors on both sides. Most crew cab pickups have a shorter bed or box to reduce their overall length.

The bed 120 includes one or more side walls 122, a tailgate 124, and a floor 126. The side walls 122, tailgate 124, and floor 126 are configured to form an open-top cargo area 128. The open-top cargo area 128 may be used for carrying or hauling cargo, such as tools, gravel, groceries, clothes, or other items. Because the bed 120 is an open-top cargo area 128, the various items being carried or hauled are exposed to the weather and the possibility of theft. For some items, such as gravel and wood, weather and/or theft are generally not a problem. However, for other items, such as carpentry tools, groceries, and clothes, being exposed to the weather and theft are generally a concern.

In an embodiment, the bed 120 includes a storage container 130. As shown in FIG. 1, the bed 120 includes a storage container 130. In the closed position, the storage container 130 may be enclosed and configured to store, haul, or carry cargo. In other words, the storage container 130 may be closed off on all sides if the top is down and the front panel is pulled out from under the base and is closed tight against the sides and back. The inside or interior of the storage container 130 may be used as a cargo container to prevent cargo from sliding, being exposed to weather, and/or being stolen.

In some examples, although one or more of the side walls of the storage container 130 may abut the bed 120 of the truck 100, the inside or interior of the storage container 130 (e.g., the area that stores, hauls, or carries cargo) is disposed in the open-top cargo area 128. For example, the inside or interior of the storage container 130 may be disposed between the side walls 122 and the tailgate 124, as well as being above the floor 126. For example, the storage container 130 is not a container inside of a compartment built in a side wall 122. Instead, the inside or interior of the storage container 130 may be disposed in the open-top cargo area 128. The storage container 130 is generally smaller than the bed 120 of the truck 100. For example, the bottom of the storage container 130, may be less than half of the square footage of the bed 120 of the truck. In some examples, the bottom of the storage container 130 may be less than a quarter of the square footage of the bed 120 of the truck. In some examples, the storage container 130 may be the same size or almost the same size as the bed 120 of the truck 100. The term “almost” accounts for the physical structure of the storage container 130.

In certain examples, the gap between the base panel 131 and bottom panel of the container 130 can include one or more trusses 170, 171, 172, and/or 173 or other sliding supports attached to a bottom edge of the front panel 203 such that when the front panel is pulled out from under the base 131, the trusses 170, 171, 172, and/or 173 provide support. That is, back, side and front panels may not have an ability to provide support to the base so the trusses 170, 171, 172, and/or 173 provide this support for them. In other examples, due to the configuration and/or material of the panels, one or more trusses 170-173 may not be included in the design.

For example, in a truss-based embodiment, a front panel of the container 130 is housed beneath a base of the container 130 (but perhaps protected by a bottom sheet or panel underneath). By sliding the panel underneath the base, the container 130 can be placed and effectively used in a variety of positions in a vehicle bed, including at the edge of a truck or trailer tailgate. If the front panel of the container 130 is pulled out and “flipped up” or in the fully closed position, then the front panel is no longer able to provide support to the floor or base of the container 130. One or more trusses 170, 171, 172, and/or 173 or movable supports are installed on the bottom of the front panel/door edge via hinges, allowing the trusses 170, 171, 172, and/or 173 to be pulled forward and provide support when the front panel cannot provide support due to its position. The example of FIG. 1 shows the trusses extending along a width of the container 130. The number of trusses and/or other support(s) 170-173 may vary (e.g., a single truss, two trusses, three trusses, four trusses, five trusses, etc.). Trusses may be located to move along a direction of panel movement (e.g., a front panel slides underneath a floor or base panel of the container 130), normal to a direction of panel movement, diagonal to a direction of panel movement, etc. In a non-truss based embodiment, one or more of a circle cam disc, pin and groove, hook and ball, block and hinge, etc., can be implemented to maintain support and front panel position without use of truss(es).

In certain examples the width of the base in which the trusses and front panel reside when the front panel is slid under the base is approximately the same length of the sum of the height of the front panel and the length of the trusses.

The storage container 130 is generally located near the tailgate 124. This location may allow a user to reach the storage container 130 without climbing into the bed 120 of the truck 100. However, the location of the storage container 130 is not limited, for example, as long as it is disposed in the bed 120. For example, the storage container 130 may be disposed near the cab 110, as opposed to near the tailgate 124. In this example, a user may reach over a side wall 122 of the bed 120 or climb into the bed 120 to access the storage container 130. Other locations and ways of accessing the storage container 130 are included within the scope of this description. As disclosed above, a glide or guide system can be installed in the bed 120 of the truck 100 to allow the storage container 130 to move along the guide in the truck bed 120.

For example, the storage container 130 may be oriented in a variety of ways in a truck bed or other vehicle platform. While many of the figures show the container 130 oriented with ends facing a side wall of a truck bed, the container 130 may be positioned such that the ends face the cab and tailgate of the truck. Other orientation or positioning is envisioned as well.

The storage container 130 may be made of one or more materials. For example, the storage container 130 may be made of plastic, metal (e.g., ferrous or non-ferrous, insulated or non-insulated, etc., such as aluminum, steel, etc.), wood, or other material. The material may be weatherproof. For example, stainless steel or plastic may be used to protect against rain and snow. The material may also prevent or at least deter theft. For example, a hard plastic, such as TEFLON®, may be used to protect against both the weather and theft.

For example, the storage container 130 may be designed to fit in the back of a truck bed or other vehicle back/space. The sides and top and/or other panels/walls of the example storage container 130 can be made of a material such as an insulated High Density Polyethylene, Acrylonitrile Butadiene Styrene (ABS) plastic, polypropylene, etc., and hinges, locks, and brackets can be made from stainless steel, aluminum, etc. The example storage container 130 is engineered to be weather resistant and lockable and also secures cargo from rolling around in the bed of the truck or other vehicle/trailer. The example container 130 is fastened to the truck bed with four stainless steel bolts securing the unit to the vehicle. In other examples, the container 130 may be held in place by the weight of the container 130 and friction between the container 130 bottom and the truck/vehicle bed. The container 130 may be built into a vehicle, sold as an accessory by an automotive dealer or manufacturer (e.g., as a bedliner, storage box, etc.), sold as an “after-market” item (e.g., a bedliner, storage box, etc.), etc.

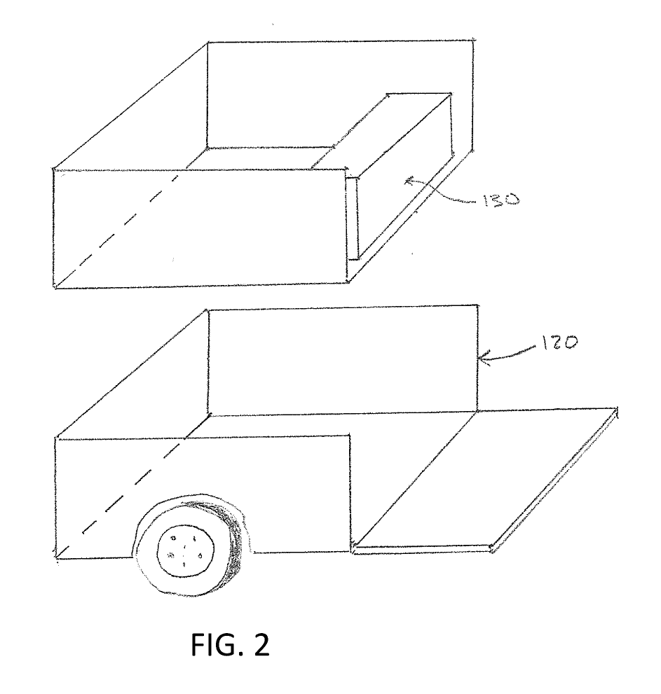

FIG. 2 illustrates an example in which a storage container 130 is positioned at an end of a truck bed 120. In certain examples, the container 130 and associated glide system are provided as a part of and/or can be connected to a bedliner. For example, a bedliner is configured to receive a storage container 130 for a bed 120 of a truck and/or other vehicle, trailer, etc. A bedliner is a liner that covers a bed of a truck. The bedliner may protect a truck bed from damage and can prevent fine-grained cargo from moving around in the bed of the truck. The storage container 130 may protect items placed in the interior of the storage container from the possibility of weather, theft, and sliding around the bed of the truck.

While certain examples utilize one or more trusses 170,171,172,173 to provide support to the base of a storage container when the front door is slid out from under the base 131, other examples include a base 131 that provides its own support and does not need additional support (e.g., because the base is constructed from a material, such as a metal, hard plastic, etc., that is constructed of material stiff enough to span from side to side without added support. In certain examples, the front panel slides under the base 131 and remains in alignment with the base 131 in an opening between the base panel 131 and a container bottom without use of a truss.

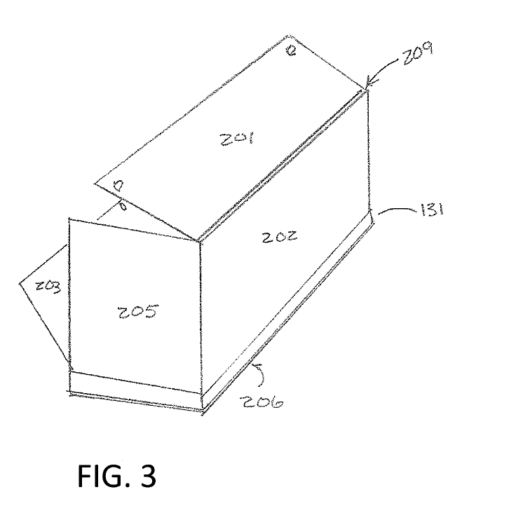

In certain examples, such as one example illustrated in FIG. 3, a top panel 201 of the box 130 can be secured while allowing a front panel 203 to open and close independently of the top panel 201. Additionally, the front panel 203 of the box 130 can be secured while the top panel 201 of the box is opened and closed. Thus, as shown in the example of FIG. 3, side panels 204, 205 and back panel 202 can be erect with respect to the base 131 while top 201 and front 203 panels are independently moveable into open and/or closed positions. In certain examples, a bottom panel 206 forms a cavity underneath the base 131 into which the front panel 103 can slide when in the open position.

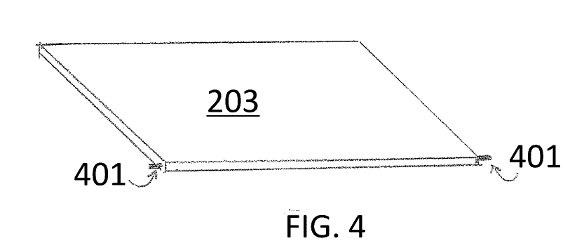

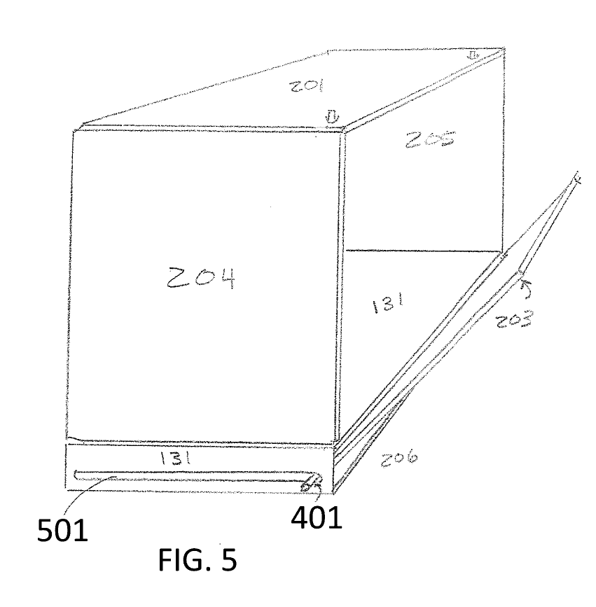

In certain examples, the front panel 203 spans an entire length of a gap between the side panels 204, 205. Stiffness of the material from which the front panel 203 is made (e.g., metal, hard plastic, etc.) provides support for the movable panel 203 without guidance from trusses. In certain examples, such as the example shown in FIGS. 4 and 5, one or more pins 401 are formed on the bottom of the front panel 203 near a side panel 204, 205 to guide movement of the panel 203 from the front of the container 130 to under the base 131 of the container 130. As shown in the example of FIG. 5, the pins 401 can slide in a slot 501 that is closed on the end. The closed slot 501 prevents the front panel 203 from being removed or dismounted from the container 130, for example.

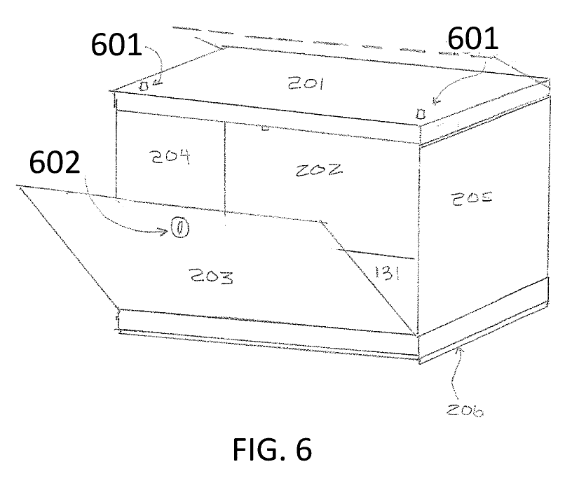

In certain examples, the top panel 201 is attached to the back panel 202 and is movable with respect to being hinged (shown in the example of FIG. 6 as a dashed line) to the back panel 202 (e.g., from a closed position “capping” the container 130 and touching the tops of the back 202, sides 204, 205 and front panel 203). The top 201 can be latched 601 to the box 130 separately from the front panel 203 and the front 203 can be latched 602 separately from the top 201. Thus, in certain examples, the front 203 can open while the top 201 is fixed and/or vice versa. In certain examples, when the top is closed and rests on the back 202, the front panel 203 is slid underneath the base 131.

As discussed above, certain examples provide a variety of devices to control the front panel 203 of the storage container 130 as the panel 203 slides out from under the base 131. The control(s) grab and constrain (e.g., stop, limit, etc.) the front panel 203 in position to swing vertically into place resting next to the side panels 204,205 and top panel 201. A variety of approaches can be used to align the front panel 203 with the side panels 204, 205 and the base 131 as well as keep the front panel 203 from inadvertently being pulled out of the cavity created between the base 131 and a bottom of the container 130.

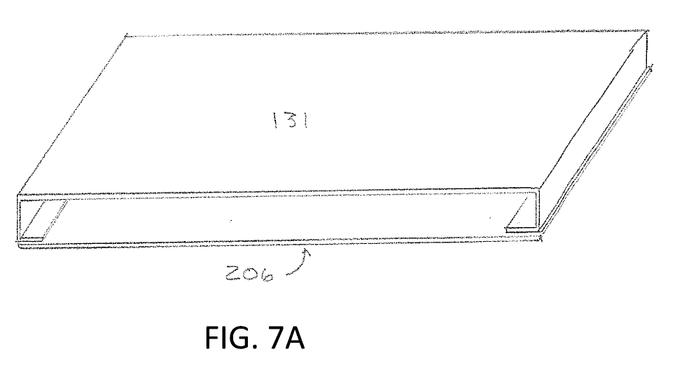

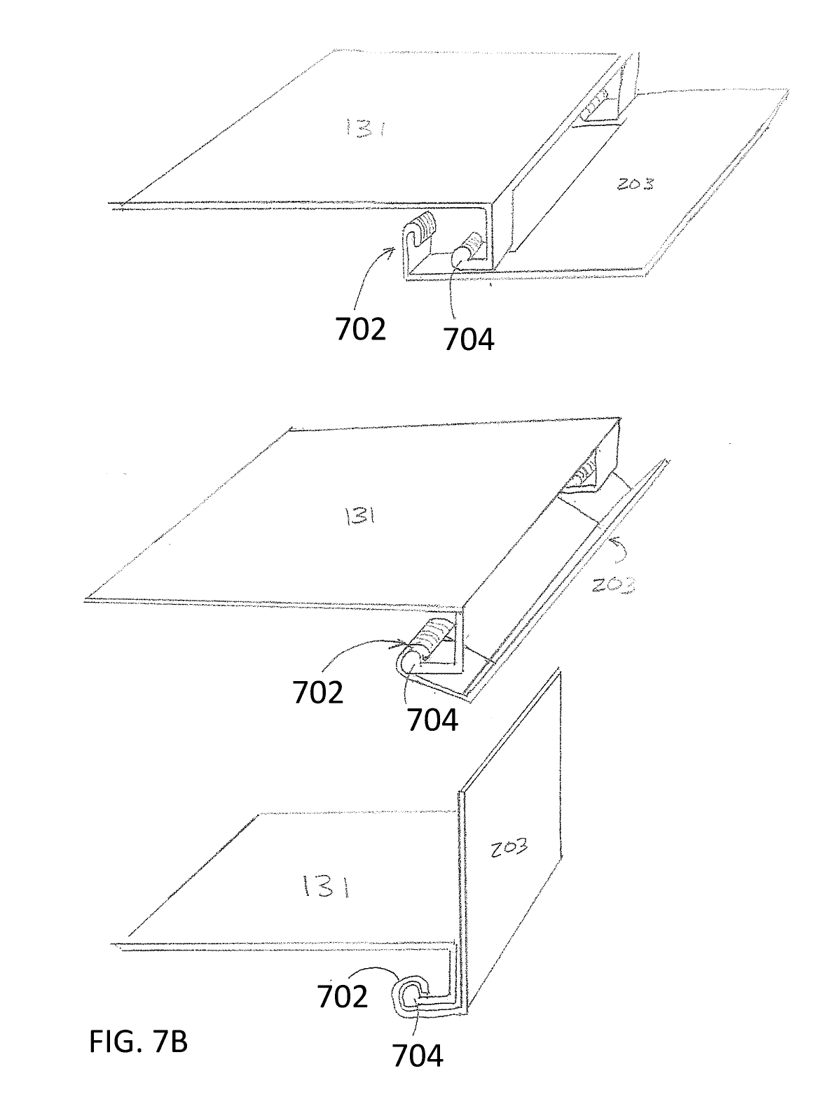

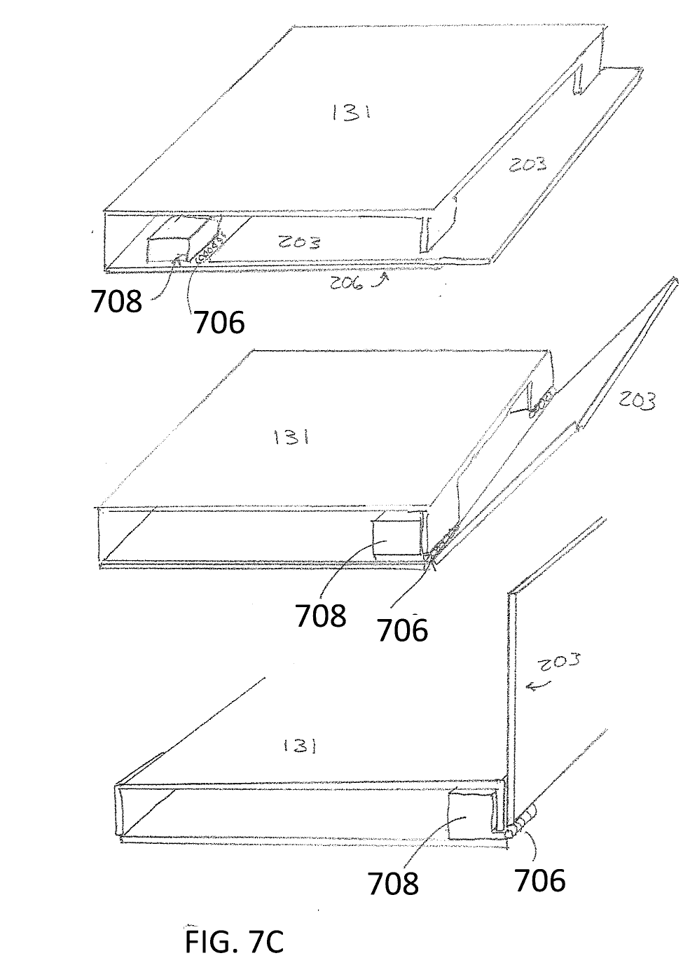

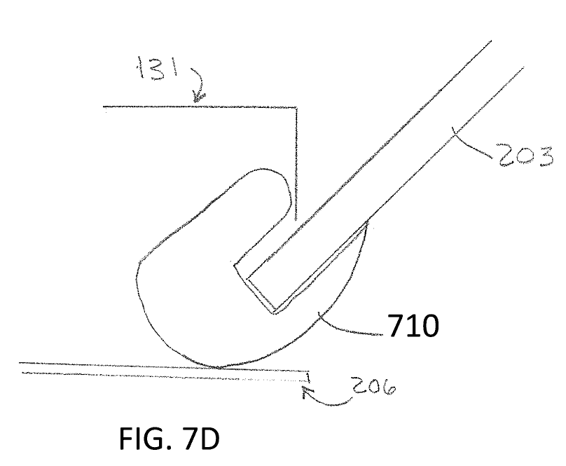

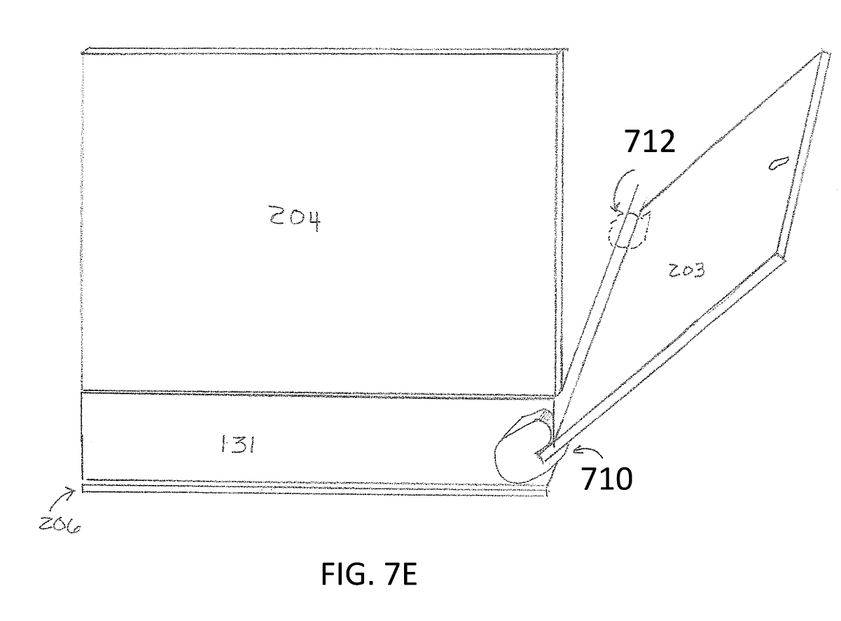

For example, FIG. 7A illustrates an example cavity formed between the base 131 and a bottom panel 206 of the storage container 130. FIGS. 7B-7E illustrate example control or constraint devices limiting motion of the front panel 203 with respect to the base 131 and/or bottom 206 of the storage container 130. For example, FIG. 7B illustrates a hook 702 and ball 704 implemented to control movement of the front panel 203 with respect to the base 131. As shown in the sequence of FIG. 7B, the hook 702 fits with respect to the ball 704 and allows the front panel 203 to pivot around the base panel 131. In this way, the front panel 203 can slide under the base 131 until the hook 702 connects with the ball 704, at which point the front panel 203 swings up until it locks normal to the base 131.

FIG. 7C illustrates another alternative example using a block and hinge for movement of the front panel 203 with respect to the base 131 and bottom panel 206 of a collapsible storage container. A hinge 706 allows the front panel 203 to swing up with respect to the base 131, and a block 708 prevents the front panel 203 from being pulled out of the base 131. Using the hinge 706, the front panel 203 can be pulled up into an erected position normal to the base 131, while the block 708 stops the panel 203 in position without moving the panel 203 beyond position.

FIGS. 7D-E illustrate another example of a collapsible storage container facilitating movement and securing of panels using cam-shaped discs 710, 712. The discs 710, 712 guide movement of the front panel 203 with respect to the base 131, bottom 206, and sides 204, 205. As demonstrated in the example of FIG. 7D, the front panel 203 of the example container moves down, guided by the cam-shaped disc 710. FIG. 7E provides another example of the front panel 203 moving with respect to the base 131, bottom 206, and side 204, guided by the cam-shaped discs 710, 712.

Thus, for example, one or more cam-shaped discs (e.g., circle cam discs, square cam discs, trapezoidal cam discs, etc.) 710, 712 and/or other object(s) having an offset center can be attached to the bottom of the front panel 203. The cam-shaped disc(s) 710, 712 and/or other object(s) can be attached near the end(s), side(s), and/or middle of the panel 203. A user can pull up on the front panel 203, and, based on the cam-shaped disc(s) 710, 712, the front panel 203 cannot come out of the box 130. Rather, the front panel 203 can only move up and down on a radius of the cam.

Glide Mechanism Examples

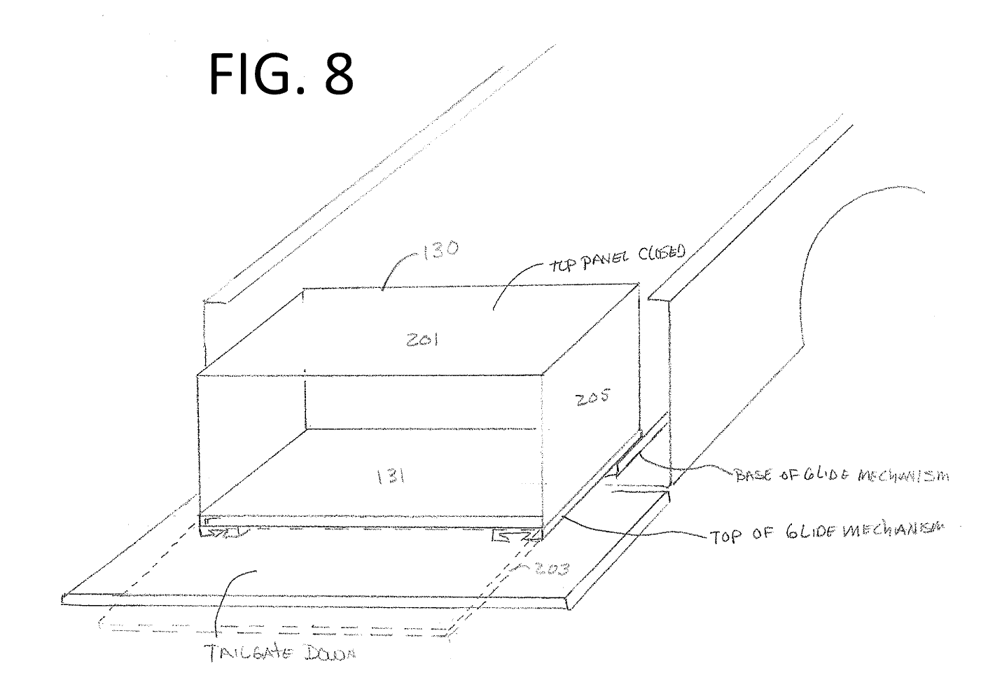

Certain examples provide a glide mechanism and/or other movement apparatus for a storage container (e.g., storage container 130). FIG. 8 illustrates a front view of the storage container 130 (e.g., collapsible or non-collapsible) shown open and laying on a truck tailgate. The open position of the front panel 203 is represented by a dashed line in the example of FIG. 8. If, as shown by the dashed line, the front panel 203 of the container 130 does not slide under the base of the container but, rather, lays flat on the bed/tailgate of the vehicle, a person must stand away from the container 130 at a distance at least equal to a height of the front panel 203 and reach over that front panel 203 to try and open the container 130.

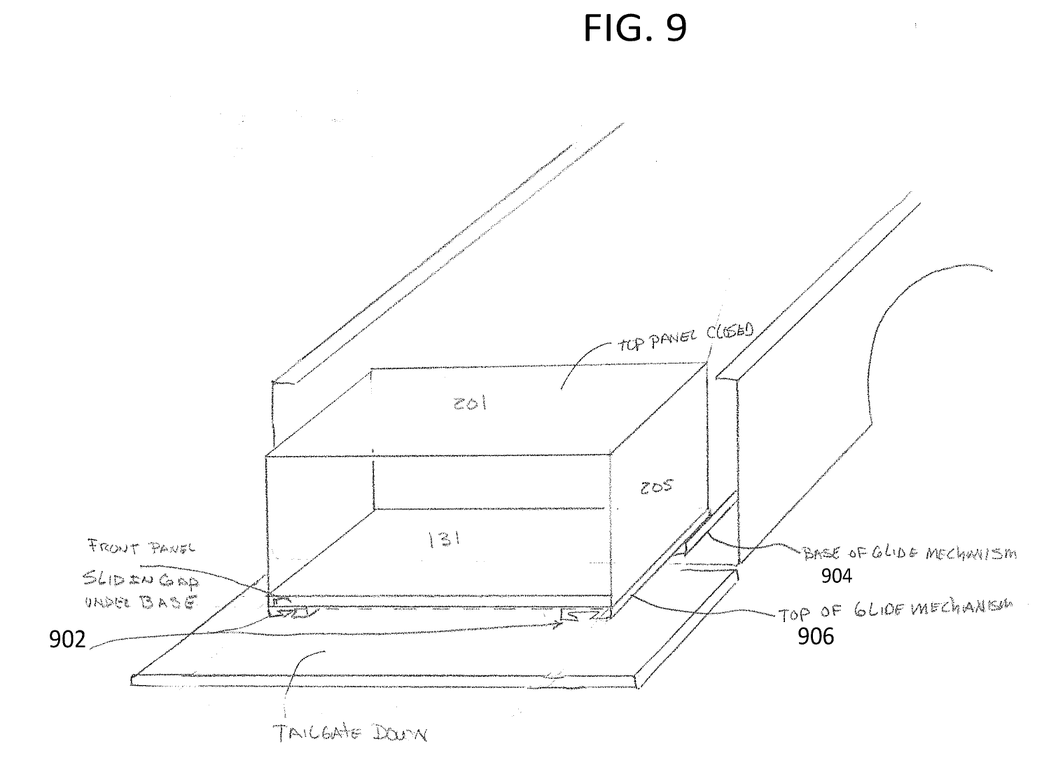

However, as illustrated in the example of FIG. 9, the front panel 203 (shown by the dotted line under the base 131) moves under the base 131 of the container 130. As a result, a person can move right up next to the container 130 rather than reaching over the extended front panel 203 at arm's length. With the addition of a glide mechanism 902, the container 130 can be moved to/near the end/edge of the vehicle bed/tailgate to facilitate easy access to the container 130 and its contents. Using the glide mechanism 902, a user can pull the container 130 toward him or her to allow the user to access an interior of the container 130 at close range.

As shown in the example of FIG. 9, the glide mechanism 902 includes two glide rails, each having a base portion 904 and a top portion 906. In the example of FIG. 9, the top or upper portion 906 does not extend beyond the base 131 of the container 130, and the upper 906 and lower 904 portions do not extend beyond the sides 204, 205 of the container 130 in the vehicle cargo area, trunk, trailer, or bed.

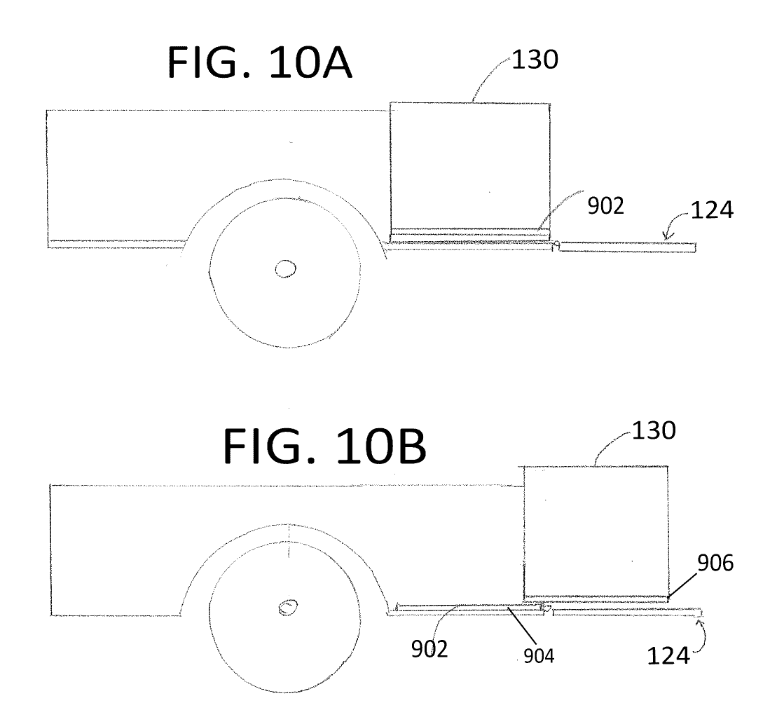

FIGS. 10A-10B illustrate another example view of the glide mechanism 902 moving the container 130 from a position in the bed/cargo area of a truck in FIG. 10A to a position over the tailgate 124 in FIG. 10B. As illustrated in the example of FIG. 10B, the base 904 of the glide mechanism 902 is connected with the truck bed, and the top 906 of the glide mechanism 902 supports the container 130 over the tailgate 124.

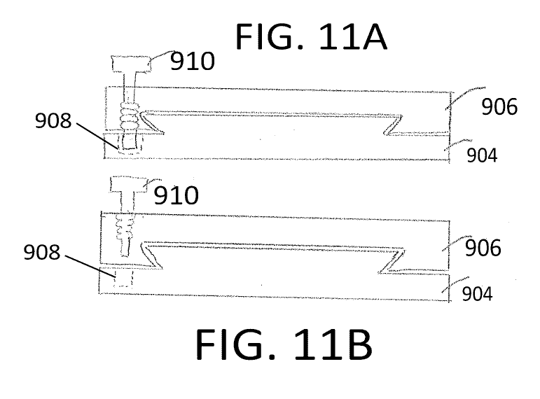

In certain examples, the glide mechanism 902 includes an index button 910. The index button 910, illustrated in the example if FIG. 11A, allows top 906 and bottom 904 glides of the glide mechanism to be “indexed” or “locked” in place. Indexing or locking occurs when a spring loaded shaft 910 can slide into a pre-drilled hole 908 in a predetermined position of the glide mechanism. In certain examples, the shaft 910 is either all the way out of the hole or all the way in the hole.

In certain examples, a profile of the glide mechanism includes top 906 and bottom 904 glide portions shaped so as to “dovetail” into each other. A dovetailing of the top 906 and bottom 904 glides allows the two pieces to slide back and forth easily. In an example, the bottom glide rail 904 is fastened to a fixed object such as a crumb rubber mat, truck bed, etc. When a user pulls up the index button 910 (e.g., releasing a lock between the top and bottom panels), he or she can easily slide the entire box 130 out towards them as shown in the example of FIG. 10.

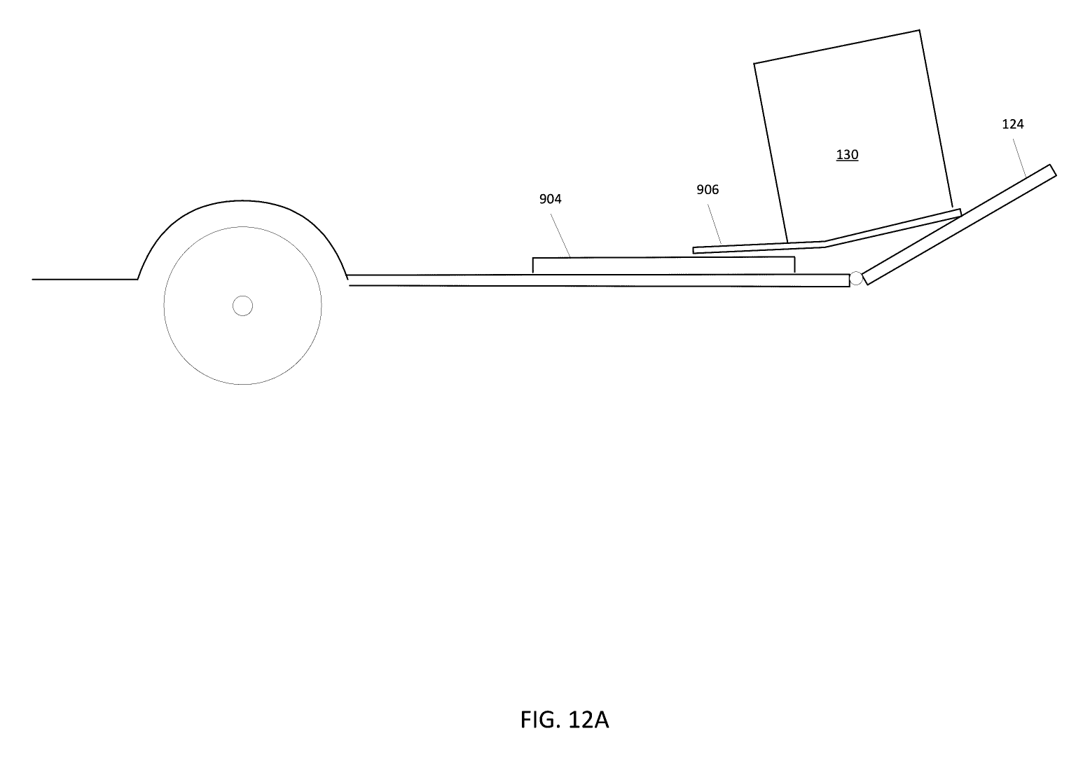

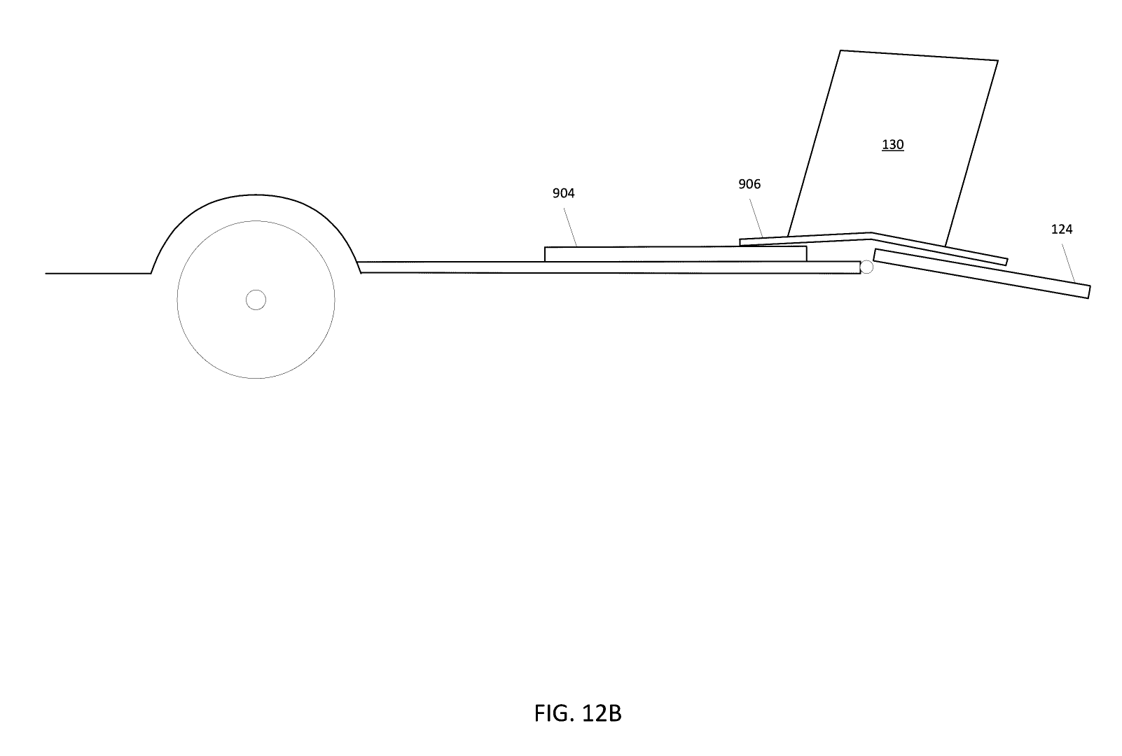

FIGS. 12A-12B illustrate views of an example glide mechanism. FIG. 12A shows an example glide mechanism including a first portion 906 resting on a second portion 904. The first or upper portion 906 is movable with respect to the second or lower portion 904. The glide top 906 passes over the glide base 904 which can be formed from a flexible material to allow the base 904 to bend slightly up or down to meet a corresponding surface 124 on which the glide mechanism rests (e.g., a face of a vehicle tailgate). For example, if all or part of the glide mechanism 902 is made of a thin or flexible metal, the base 904 is positioned slightly above the vehicle mounting surface (e.g., the tailgate) 124 to avoid banging into the surface 124. If the base 904 (and potentially the upper portion 906 as well) of the glide mechanism 902 is formed from a flexible material such as polyethylene, ultra-high-molecular-weight (UHMW) polyethylene, polypropylene, thin and/or flexible metal (e.g., aluminum, etc.), etc., the glide mechanism can bend up and/or down slightly (e.g., bend up to reach higher tailgate 124 or bend down to ride along the tailgate 124 and take stress off the glide mechanism, etc.).

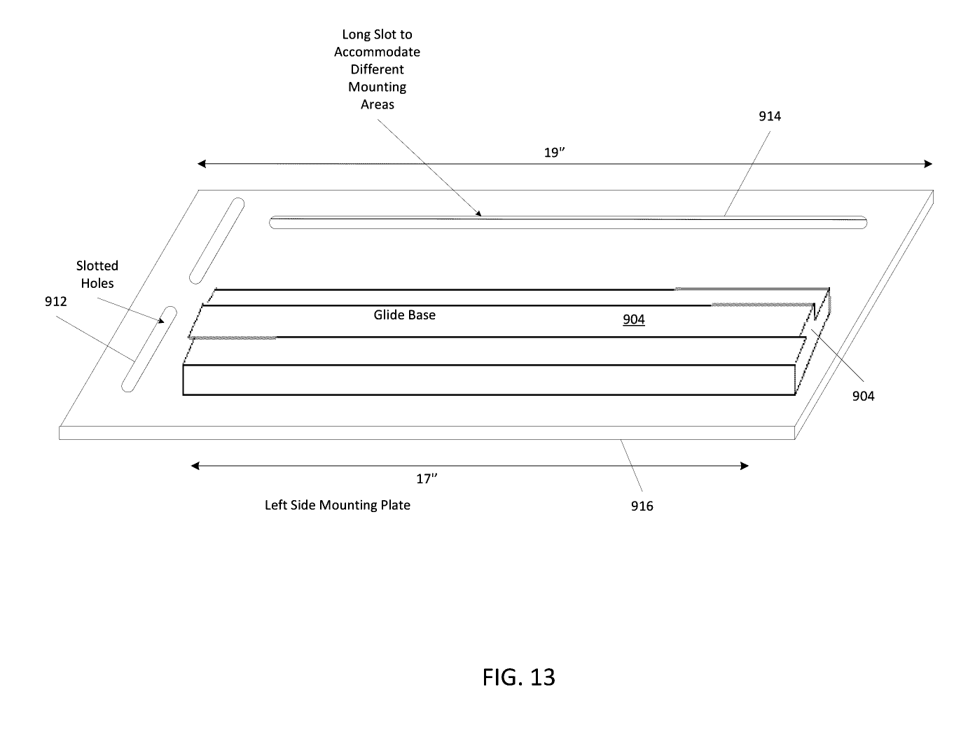

In certain examples, such as the example of FIG. 13, the glide mechanism includes holes or slots 912 allowing the glide mechanism to be universally installed in variety of vehicles. An attachment mechanism such as a mounting plate 916 incorporated into and/or attached to the glide base 904 is slotted 912, 914 to allow movement of the upper portion 906 (not shown in FIG. 13) of the glide mechanism along the lower portion 904 of the glide mechanism while maintaining the glide mechanism at a height above the vehicle mounting surface (e.g., about an inch above the truck bed) and a desired distance from an end of the vehicle mounting surface (e.g., from the truck cab to about an inch from the end of the truck bed). In certain examples, the lower portion 904 is slotted in both east and west directions as well as north and south directions (e.g., both slotted holes 912 and a long slot 914 to accommodate different mounting areas) to allow the glide mechanism to adapt (e.g., be bolted to, etc.) to various vehicles (e.g., various truck and/or trailer beds, etc.).

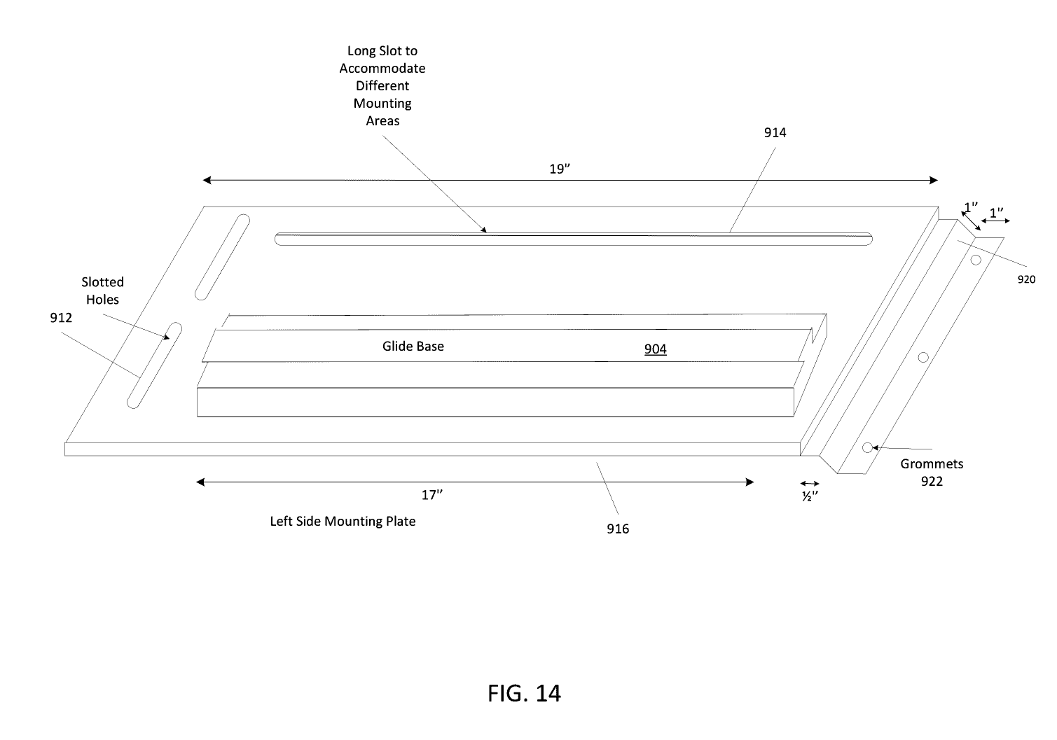

FIG. 14 shows a base portion 904 of an example glide mechanism with an added fabric (e.g., nylon or poly type material, etc., that is strong but flexible) tab 920 on an end of the mounting plate 916 (e.g., 0.125 inch aluminum mounting plate, etc.) under the base portion 904 of the glide mechanism. The tab 920 allows the glide mechanism to be mounted on a bedliner (e.g., which is about one inch higher than the actual metal bed of the trailer or truck bed), for example. When the bedliner extends to within a couple of inches of the tailgate, the bedliner tapers down to the metal bed of the underlying vehicle. Thus, the flexible fabric tab 920 allows the base 904 of the glide mechanism to follow this taper down so that the glide mechanism can be screwed or bolted into the metal truck bed and/or other vehicle bed (e.g., through the bedliner) such as through one or more holes or grommets 922.

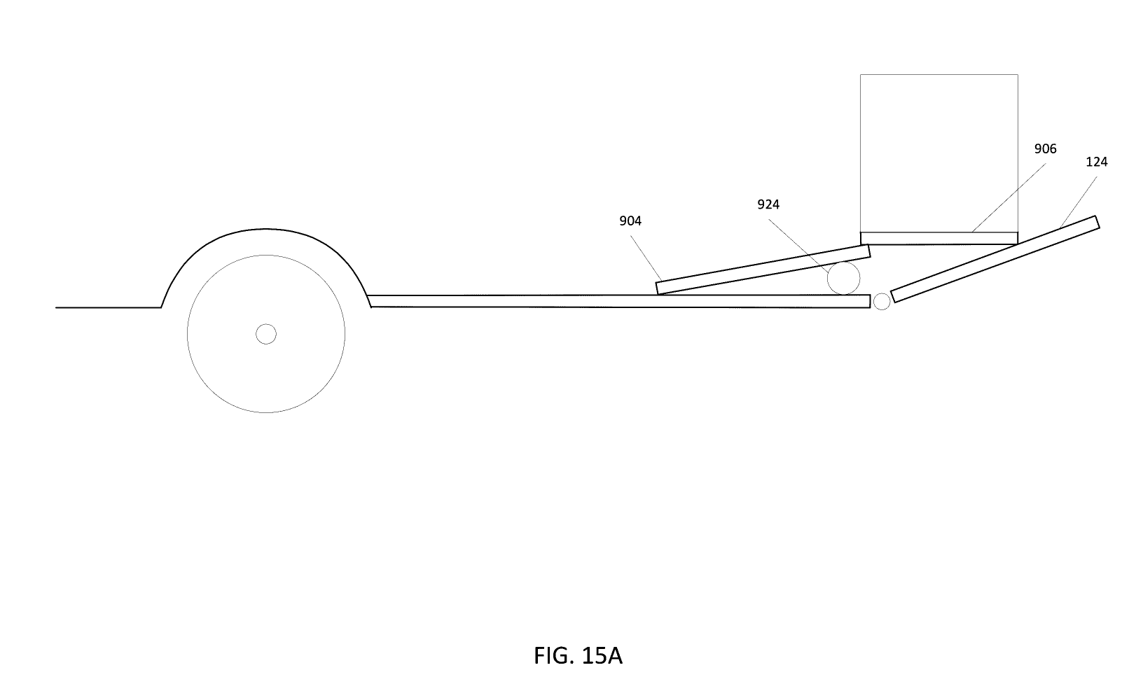

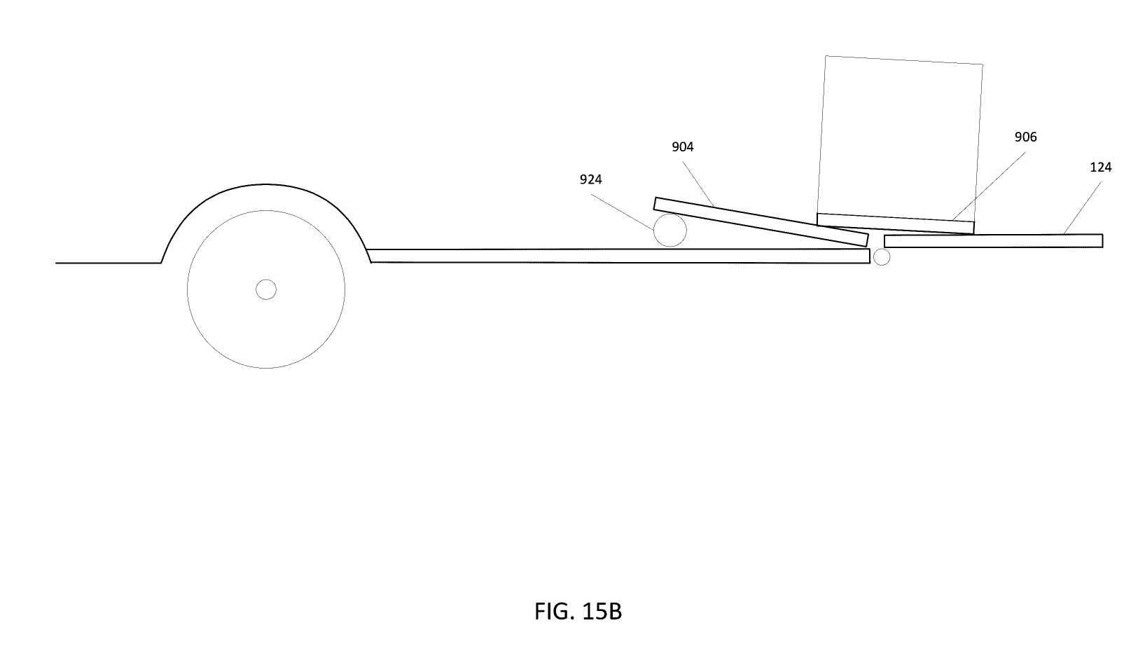

In certain examples, such as the examples of FIG. 15A-15B, a rubber mounting bushing 924 can be mounted under the bottom portion 904 of the glide mechanism (e.g., along a mounting slot 914 in the mounting plate 916 (not shown in the examples of FIGS. 15A-15B)). As shown in the example of FIG. 15B, flexibility in the rubber bushing 924 allows the glide mechanism to flex or move slightly up and down to follow variation in vehicle surface (e.g., variation between truck bed and tailgate height) 124.

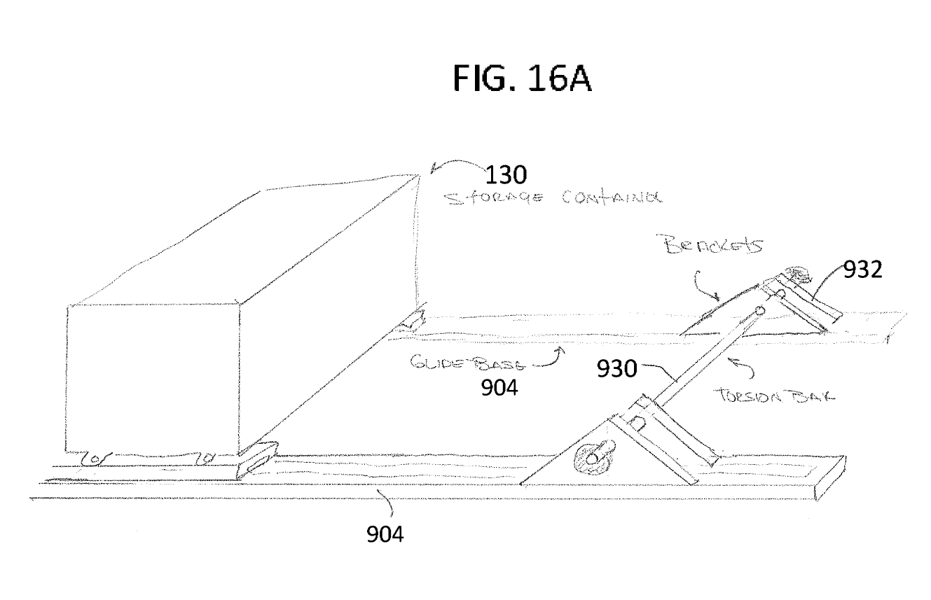

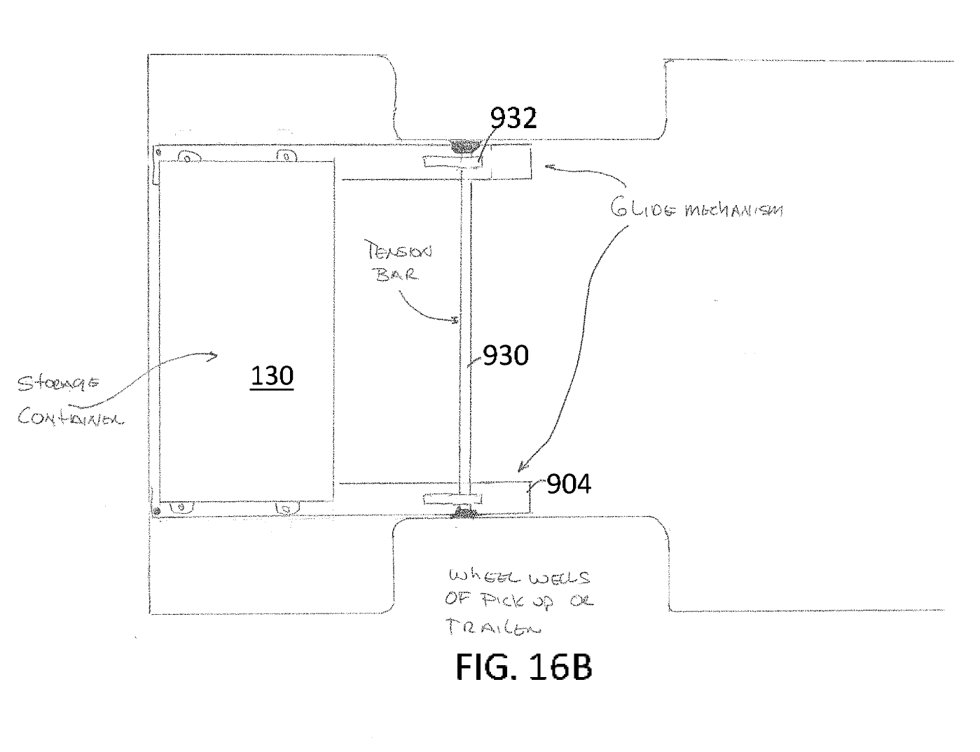

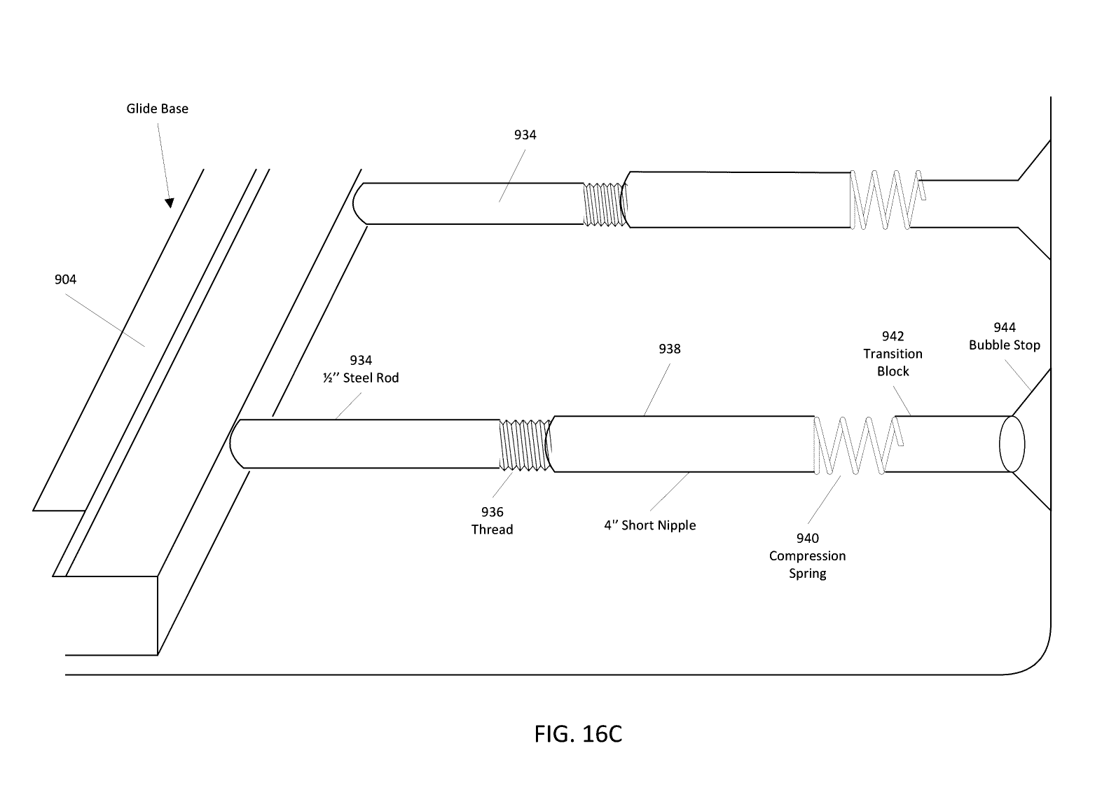

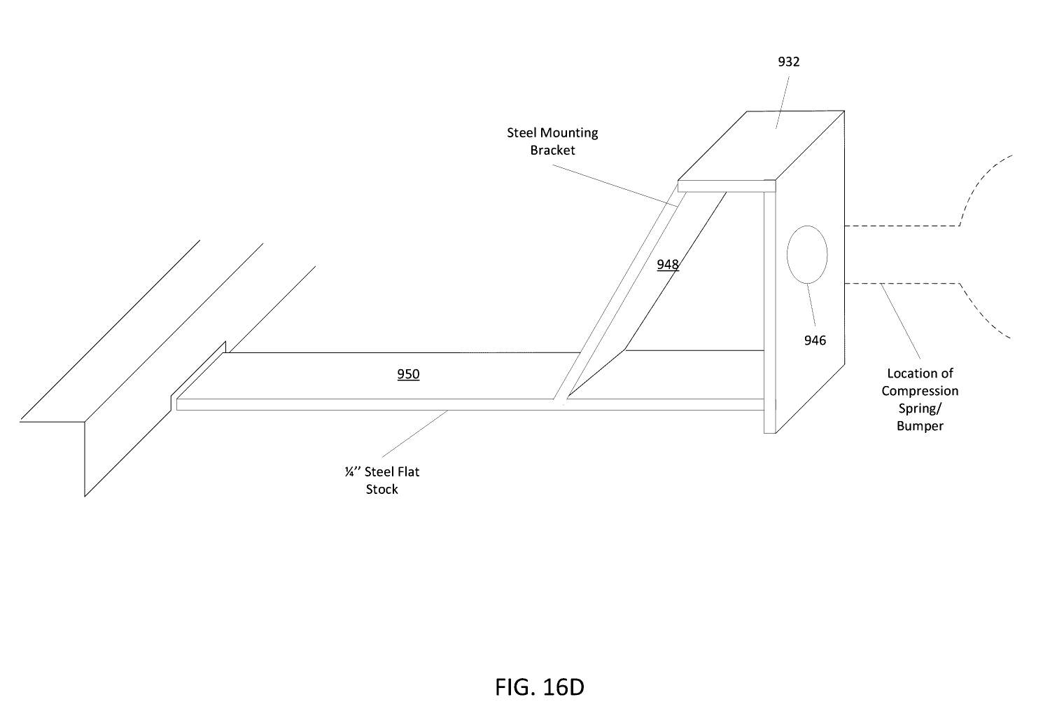

FIGS. 16A-16D show an alternate fastener between the glide mechanism and its vehicle surface. As shown in the example of FIG. 6A, a torsion bar 930 is mounted on brackets 932 that are fixed to an extended glide mechanism base 904. As illustrated in FIG. 16B, the torsion bar 930 exerts pressure on an outside face of the wheel wells to hold the brackets 932 (and, therefore, the base 904 of the glide mechanism) in place.

FIG. 16C shows an alternative to the torsion bar 930 in which a rod 934 including threads 936 is threaded inside a nipple or connector 938 with a compression spring 940 inserted into a transition block 942. The transition block 942 is in contact with a bubble stop 944. In some examples, the transition block 942 has a rounded end so the bubble stop 944 can rotate when the sidewall of the cargo area is not exactly perpendicular.

FIG. 16D shows further detail for the mounting bracket 932 into which the torsion rod 930, bubble stop 944, and/or other compression rod/bumper can be inserted. The mounting bracket 932 shown in the example of FIG. 16D includes an opening 946 for the rod/bar/bumper/etc., an angled support member 948, and a flat member 950 which fits into and/or against a side of the cargo area into which the bracket 932 is mounted. For example, the mounting bracket 932 can be inserted, via the flat member 950, into a slit or slot in a sidewall of the cargo area; inserted, via the flat member 950, into a mounting or guide base; inserted, via the flat member 950, under a protrusion along a sidewall of the cargo area, etc.

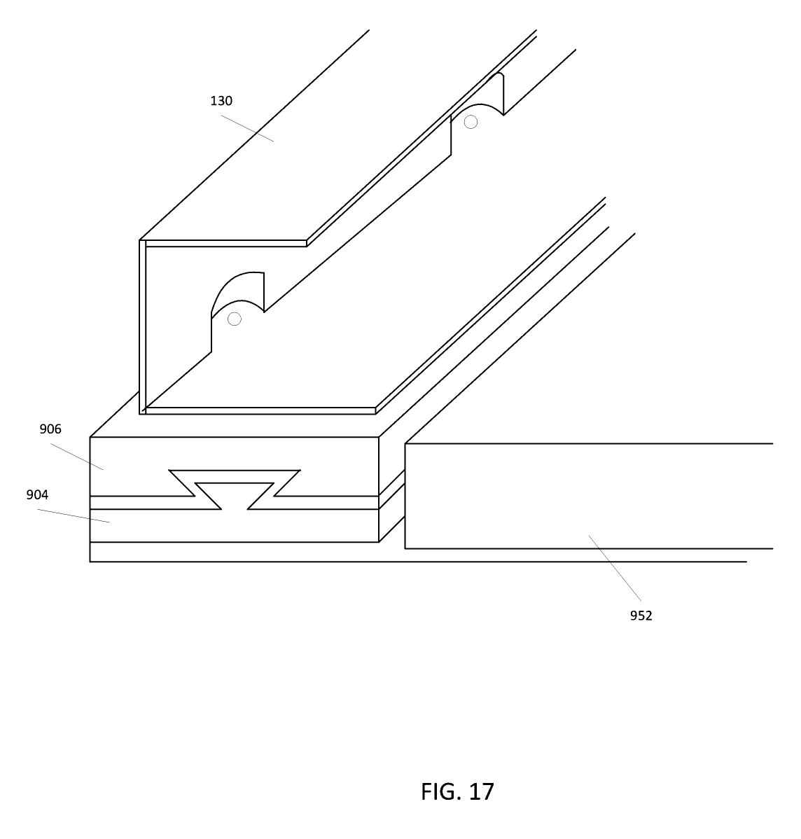

FIG. 17 shows an alternate method to hold the glide mechanism in a vehicle cargo area (e.g., the bed of a pickup truck) using a heavy mat 952. In the example of FIG. 17, an extended base 904 is attached to the bed or floor of the cargo area, such as by screwing or gluing the base to a heavy material such as a crumb rubber mat 952, etc. The weight of the mat 952 holds the glide base 904 in place such that the glide mechanism 904, 906 operates securely and reliably to move the container 130.

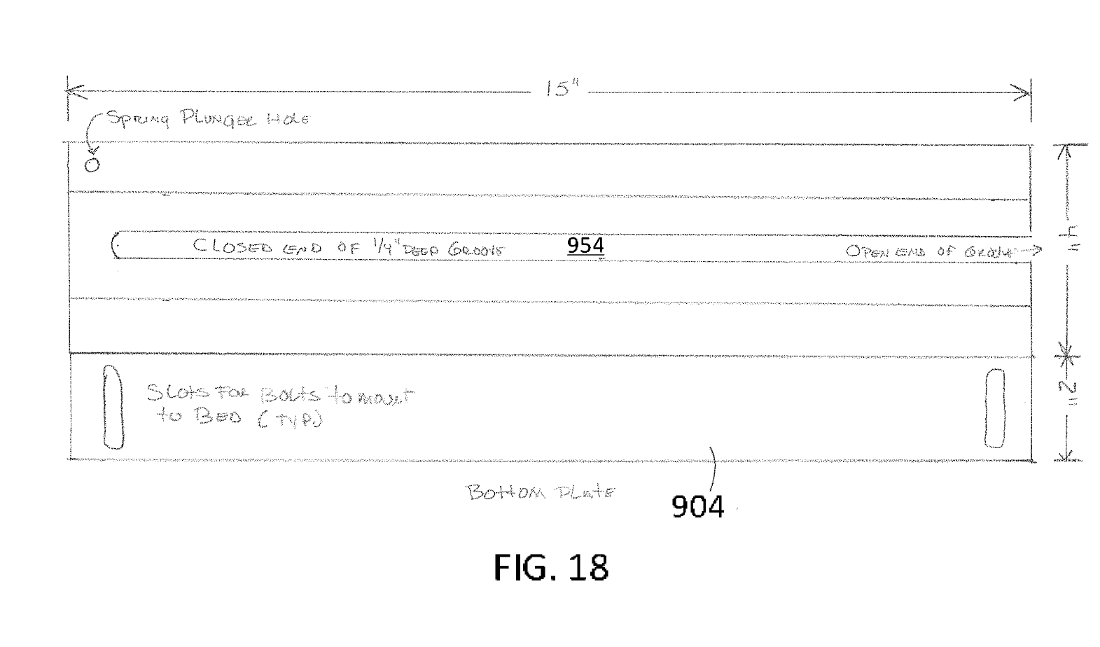

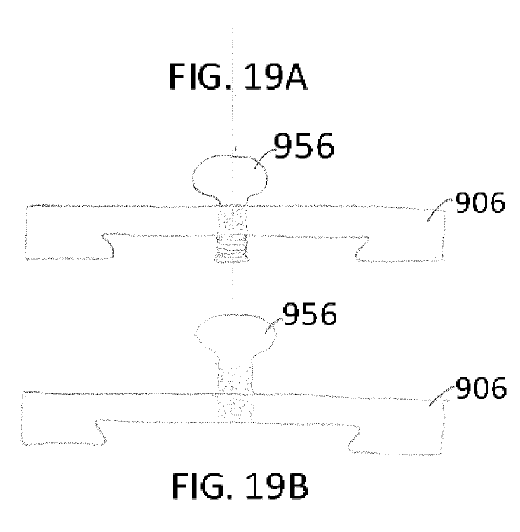

In certain examples, although the index button described above (e.g., index button 910) can hold the storage container 130 in place in most cases, a feature can be added to the base 904 and top 906 of the glide mechanism to prevent separate of the pieces 904, 906 in the event of a sudden and/or violent shift (e.g., a driver of a vehicle in which the glide mechanism and box have been installed slamming on the brakes at high speed, etc.). To help guard against movement of the container 130 in such circumstances, a closed end groove 954 can be incorporated into the glide base 904, and a corresponding bolt 956 (shown in FIGS. 19A-19B) can be included in the top plate 906 and aligned with the groove 954. As shown in the example of FIG. 18, the groove 954 has a closed end and an open end to allow the bolt 956 to enter the groove 954 and slide to the closed end. When the bolt 956 is turned so that the bolt 956 is protruding from the groove 954, the bolt 956 prevents the top portion 906 of the glide mechanism from completely sliding out of the groove 954 since the bolt 956 hits the closed end of the groove 954 and stops the slide. The groove 954 and bolt 956 can help prevent the glide mechanism from moving away from the cab or front of the cargo area of the vehicle (e.g., the bed of the truck, etc.). For example, the groove 954 and bolt 956 serve as a tongue and groove arrangement to allow the top 906 and bottom 904 portions of the glide mechanism to self-align and facilitate movement of the storage container. In some examples, a plurality of stop points, detents, etc., can be incorporated in the glide mechanism to help prevent the container and/or glide mechanism from moving uncontrollably.

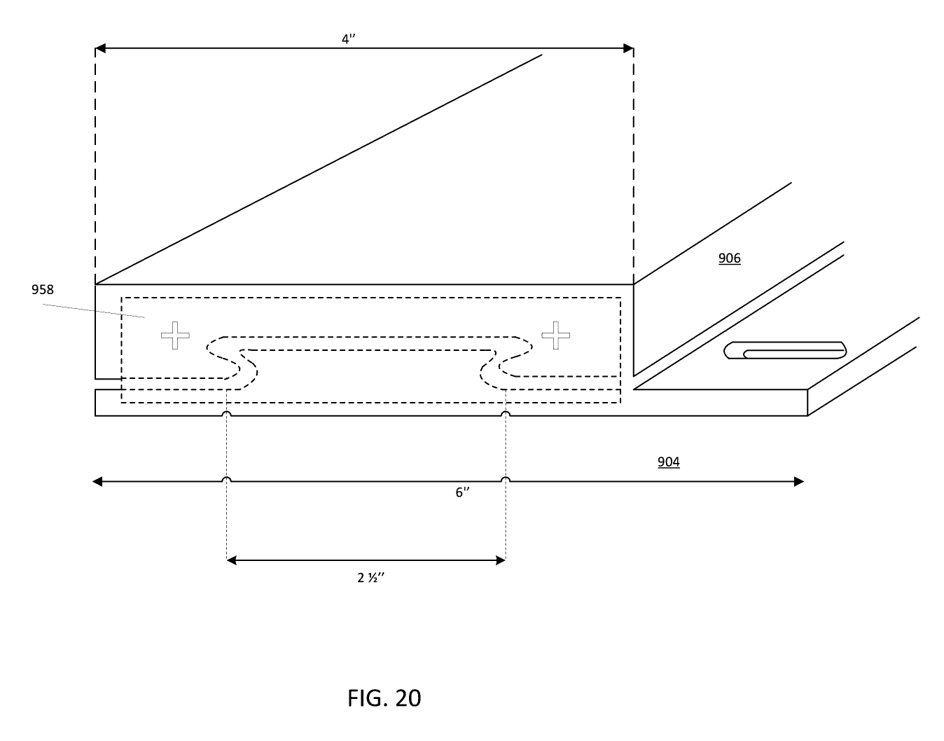

In certain examples, such as the example of FIG. 20, to help prevent the glide mechanism from moving away from an end of the cargo area (e.g., an end of the tailgate, etc.) towards a top of the cargo area (e.g., towards the cab of the truck, etc.), a plate 958 can be installed over an end of the top plate 906 of the glide mechanism. The plate 958 prevents the glide mechanism from traveling toward the cab, for example, unless the plate 958 is removed.

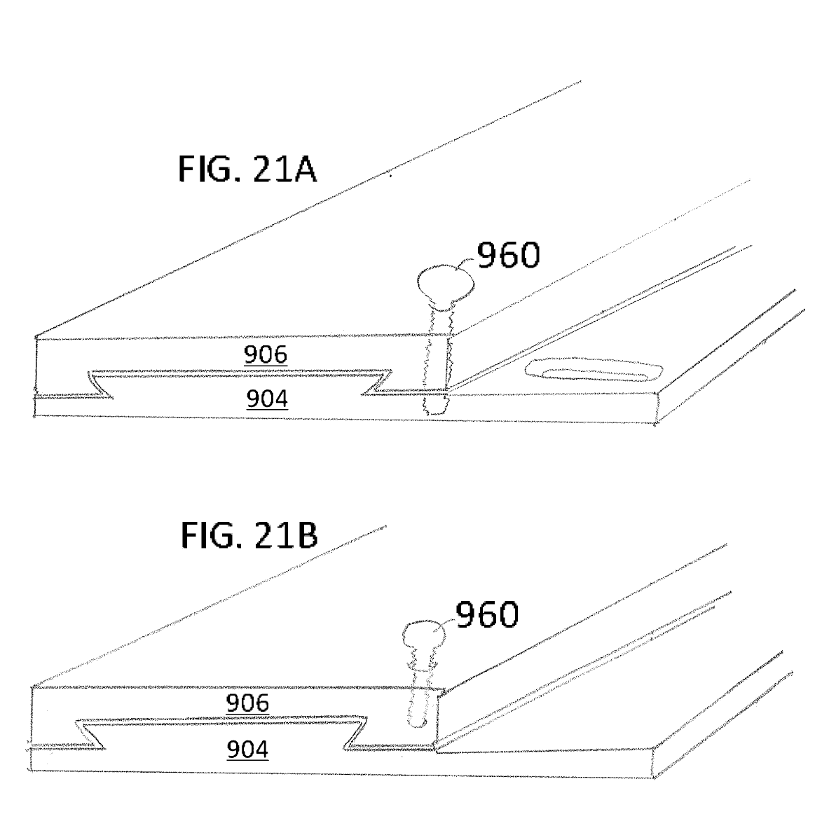

In an alternative example, such as the example of FIGS. 21A-21B, a screw 960, such as a spade head thumb screw, etc., can be threaded into the base plate 904 from the top plate 906 of the glide mechanism to prevent the top portion 906 from moving in either direction (see the example of FIG. 21A). When unthreaded, the screw 960 allows the top glide 906 to move in either direction (see the example of FIG. 21B).

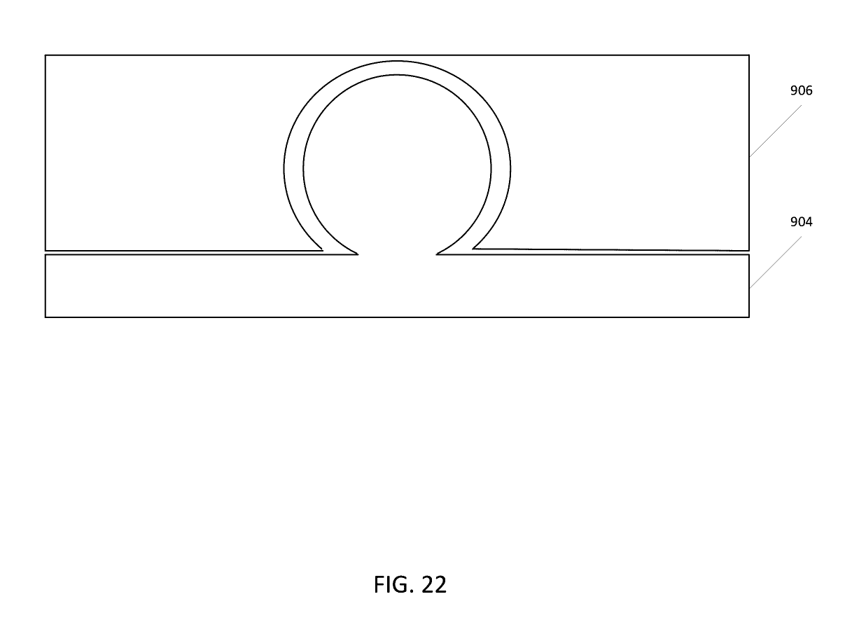

FIG. 22 shows another alternative embodiment of a glide mechanism in which, rather than a tongue and groove, as described in various examples above, a ball and tube implementation joins the base portion 904 and upper portion 906 of the example glide mechanism. Other aspects of such a glide mechanism can be implemented as described above with respect to the base 904 and top 906 portions, for example.

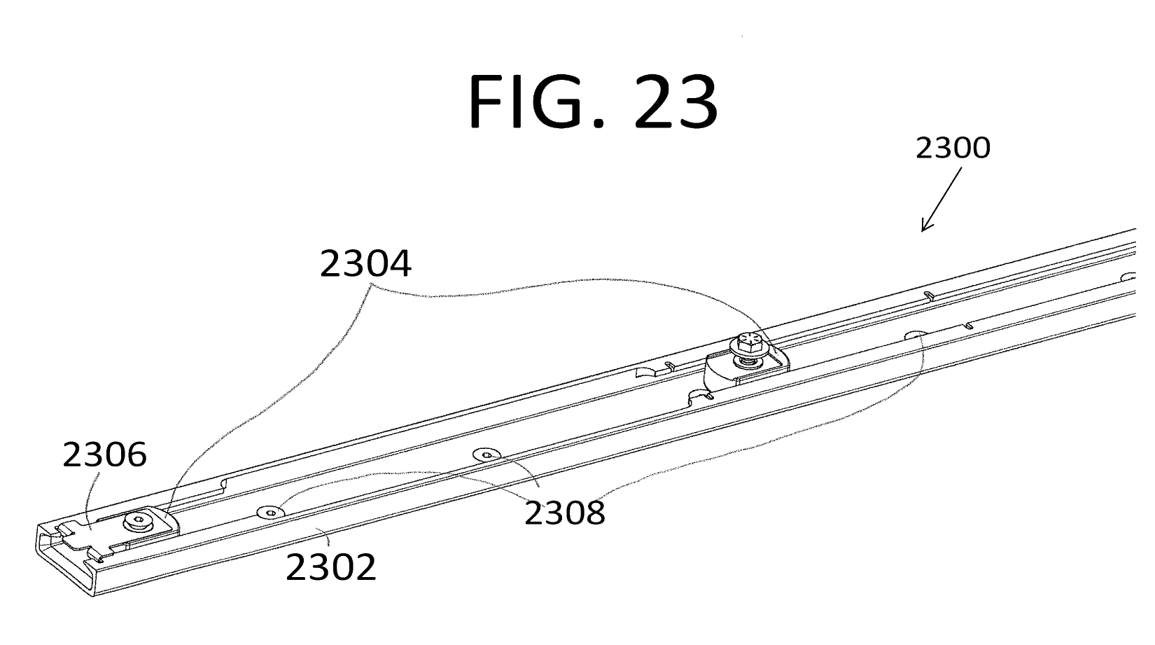

FIG. 23 illustrates an alternative “fast track” glide mechanism 2300. As with the example glide mechanism 902, described in various examples above, the glide mechanism 2300 includes a base 2302. However, instead of a top plate, two “feet” 2304 slide in a groove of the base 2302. With two glides 2300 and two feet 2304 per glide 2300, a total of four feet 2304 are present in a cargo area installation, for example.

In some examples, the glide base 2302 includes one or more openings in its track so that the foot 2304 slides in the track of the base 2302, and an attached storage container cannot be lifted off the base 2302. One or more openings allow the container to be lifted off of the base 2302.

FIG. 23 shows an example isometric view of the base 2302 and the feet 2304, as well as an indexing clip 2306. Also illustrated in the example of FIG. 23 are the screws 2308 used to attach the base 2302 to the cargo area (e.g., the bed of a pickup truck, etc.). The corresponding container (e.g., storage container 130) which is mounted on top of the feet 2304 is not shown so that the details of the glide mechanism 2300 can be viewed in the example of FIG. 23. Additionally, in the example view shown in FIG. 23, the top of the base 2302 cut away to allow the back foot 2304 to tilt up (e.g., allowing an angle of the container to slope down so the container can follow the profile of a tailgate, etc.) or be raised straight up to free the container from the glide mechanism 2300 altogether. In some examples, the container can be freed from the glide mechanism 2300 only at certain points (e.g., points along the base 2302 at which the base 2302 has wider openings in its track to allow the container to be lifted free of the base 2302. In some examples, rather than the indexing clip 2306, the glide mechanism 2300 utilizes a screw or a screw and a tab, to constrain and guide the container with respect to the glide base 2302.

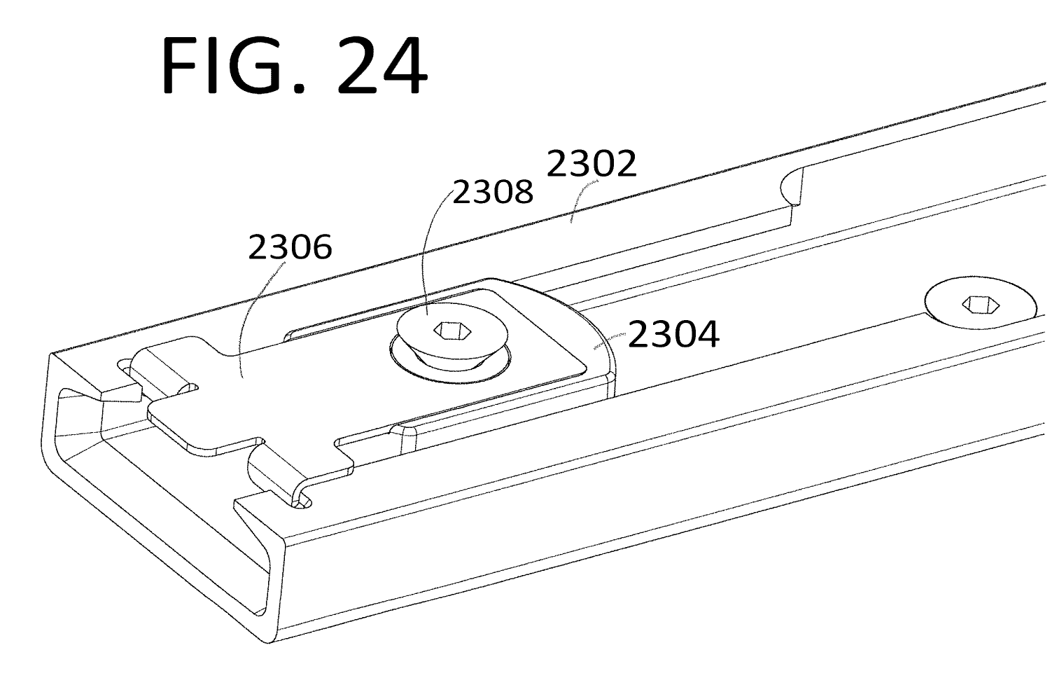

FIG. 24 shows a closer view of an example indexing clip 2306. In some examples, the indexing clip 2306 is a piece of flexible metal (e.g., stiff enough to hold the container in place but malleable enough to bend to allow the container to be free of a notch in the glide mechanism base 2302, etc.). When bent, the indexing clip 2306 frees the container, but, when the indexing clip 2306 is in a relaxed (e.g., unbent) position, the clip 2306 holds the container from sliding on the bottom glide plate 2302. The indexing clip 2306 holds the container from moving forward and/or backward on the bottom plate 2302. In some examples, such as the example of FIG. 24, the screw 2308 is tapered and serves as an attachment point where the bottom of the storage container (e.g., container 130) is attached to the foot 2304, sandwiching the indexing clip 2306 between the container and the foot 2304.

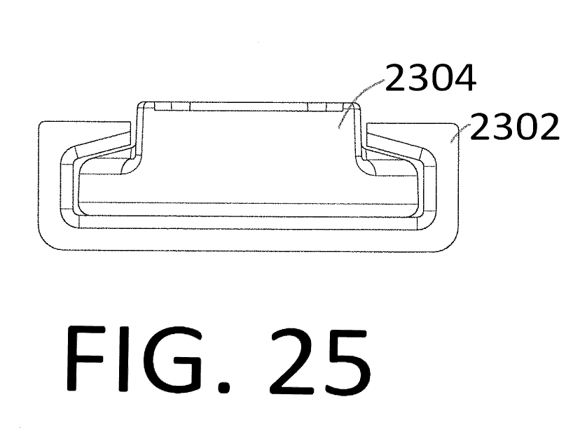

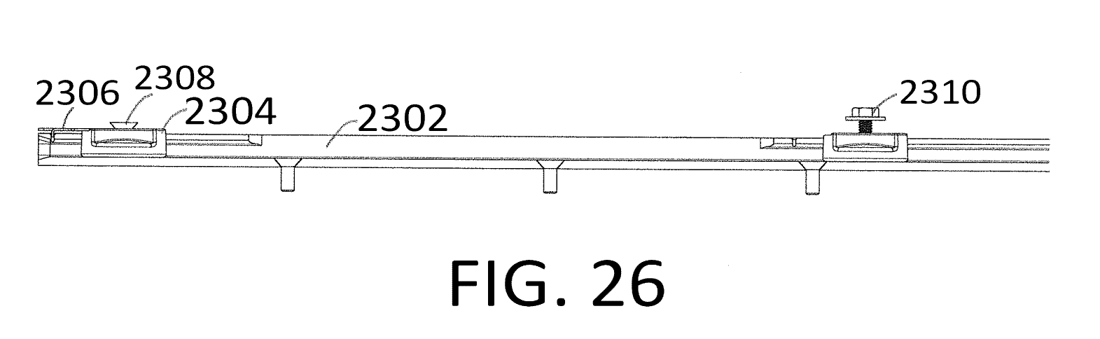

FIG. 25 depicts a profile view of an example base plate 2302 and foot 2304 of the glide mechanism 2300. FIG. 26 is another illustration of the glide base 2302 including the foot 2304, the indexing clip 2306, and the screw 2308. The example of FIG. 25 also includes a bolt 2310 through which the container can be attached to the glide mechanism base 2302.

In other examples (not pictured), rather than screwing the glide mechanism base into a cargo area floor (e.g., a truck bed), tie-downs (e.g., straps, ropes, etc.) can be used to slide along a bed rail system and connect to the storage container (e.g., via rod, clasp, tie, etc.) to steady the container while allowing it to be moved, removed, etc., without drilling holes into the truck bed for the glide system.

### CONCLUSION

Thus, certain examples provide a glide mechanism to allow an automobile storage container to be affixed to and yet move within a vehicle (e.g., a truck bed, trailer, trunk, etc.). For example, a flexible guide mechanism extends along a truck bed from a cab of the truck to a tailgate of the truck and facilitates movement of a mounted storage container along the length of the glide mechanism for ease of positioning, access, and safety.

Certain examples described above provide a movement apparatus to guide a storage container in a vehicle cargo area. The example movement apparatus includes a base portion secured to the vehicle cargo area, the base portion extending along at least a portion of a length of the vehicle cargo area, the base portion configured to facilitate movement of the storage container along the base portion. The example movement apparatus includes an attachment mechanism to receive and hold the storage container with respect to the base portion, the attachment mechanism to hold the storage container and allow the storage container to move with respect to the base portion via the attachment mechanism.

Certain examples described above provide a device including a means for facilitating movement of a storage container with respect to a vehicle cargo area. The example device also includes a means for securing the storage container with respect to the means for facilitating movement of the storage container to allow the storage container to move with respect to the vehicle cargo area. In some examples, the means for facilitating movement of the storage container includes a base portion secured to the vehicle cargo area and extending along at least a portion of a length of the vehicle cargo area to allow the storage container to move along the at least a portion of the length of the vehicle cargo area. In some examples, the means for securing the storage container includes an attachment mechanism configured to receive and hold the storage container with respect to the base portion and allow the storage container to move with respect to the base portion via the attachment mechanism. In some examples, the attachment mechanism includes at least one of an upper glide portion and a foot movable with respect to the base portion.

While the inventions have been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from the spirit or scope of the present inventions. Therefore, it is intended that the inventions not be limited to the particular embodiments disclosed herein.

1. A movement apparatus to guide a storage container in a vehicle cargo area, the apparatus comprising:
a base portion secured to the vehicle cargo area, the base portion extending along at least a portion of a length of the vehicle cargo area, the base portion configured to facilitate movement of the storage container along the base portion; and
an attachment mechanism to receive and hold the storage container with respect to the base portion, the attachment mechanism to hold the storage container and allow the storage container to move with respect to the base portion via the attachment mechanism.

2. The movement apparatus of claim 1, wherein the storage container is to be mounted to the movement apparatus such that the storage container is positionable at an outside edge of the cargo area for access to the storage container without reaching over the cargo area.

3. The movement apparatus of claim 2, wherein the outside edge of the cargo area comprises an edge of a tailgate of a truck.

4. The movement apparatus of claim 1, wherein the attachment mechanism comprises an upper glide portion movable with respect to the base portion.

5. The movement apparatus of claim 1, wherein the upper glide portion is connected with the base portion via a tongue and groove connection.

6. The movement apparatus of claim 1, wherein the upper glide portion is connected with the base portion via a ball and tube connection.

7. The movement apparatus of claim 1, wherein the attachment mechanism comprises a foot movable with respect to the base portion.

8. The movement apparatus of claim 1, wherein the foot includes an indexing screw to removably affix the storage container to the foot.

9. The movement apparatus of claim 1, wherein the base portion is formed from a flexible metal to provide flexible movement with respect to a portion of the vehicle cargo area.

10. The movement apparatus of claim 9, wherein the portion of the vehicle cargo area comprises a tailgate.

11. The movement apparatus of claim 1, wherein the attachment mechanism is tiltable to allow the storage container to be removed from the attachment mechanism.

12. The movement apparatus of claim 1, wherein the base portion includes a groove and the attachment mechanism includes a bolt to fit in the groove.

13. The movement apparatus of claim 1, wherein the movement apparatus includes at least two base portions each with at least one attachment mechanism, the at least two base portions aligned to facilitate movement of the storage container using the attachment mechanism from each base portion concurrently.

14. The movement apparatus of claim 1, further comprising a mounting plate to attach the base portion to the vehicle cargo area.

15. The movement apparatus of claim 1, further comprising a flexible mounting bushing mounted under a bottom portion of the glide mechanism.

16. A device comprising:
a means for facilitating movement of a storage container with respect to a vehicle cargo area; and
a means for securing the storage container with respect to the means for facilitating movement of the storage container to allow the storage container to move with respect to the vehicle cargo area.

17. The device of claim 16, wherein the means for facilitating movement of the storage container comprises a base portion secured to the vehicle cargo area and extending along at least a portion of a length of the vehicle cargo area to allow the storage container to move along the at least a portion of the length of the vehicle cargo area.

18. The device of claim 17, wherein the means for securing the storage container comprises an attachment mechanism configured to receive and hold the storage container with respect to the base portion and allow the storage container to move with respect to the base portion via the attachment mechanism.

19. The device of claim 18, wherein the attachment mechanism comprises at least one of an upper glide portion and a foot movable with respect to the base portion.

20. The device of claim 16, wherein the storage container is to be mounted to the means for securing the storage container such that the storage container is moveable along the means for facilitating movement of the storage container to a position at an outside edge of the cargo area for access to the storage container without reaching over the cargo area.

21. The device of claim 19, wherein the outside edge of the cargo area comprises an edge of a tailgate of a truck.
